(19) United States
(12) Patent Application Publication
(10) Pub. No.: US 2006/0088641 A1
(43) Pub. Date: Apr. 27, 2006

(54) Method for mass producing whole-seed cracker

(75) Inventors: Brian Wendel, Santa Monica, CA (US); Josh Wendel, Boulder, CO (US); Skip Latimer, Broomfield, CO (US); Thomas Krasomil, Longmont, CO (US); Stephen Vogel, Englewood, CO (US)

Correspondence Address: GREENLEE WINNER AND SULLIVAN P C, 4875 PEARL EAST CIRCLE, SUITE 200, BOULDER, CO, 80301, US

(73) Assignee: Jungle Enterprises, LLC, Santa Monica, CA (US)

(21) Appl. No.: 11/218,306

(22) Filed: Sep. 1, 2005

Related U.S. Application Data
(60) Provisional application No. 60/606,578, filed on Sep. 1, 2004.

(51) Int. Cl. A21D 10/00

(52) U.S. Cl. 426/549

(57) ABSTRACT

A method for mass producing whole-seed crackers as a dehydrated food product is provided. In one embodiment a raw food product is produced. Mucilage-producing whole seeds, preferably flax seeds, are soaked in water to cause them to produce a mucilage, but not long enough to cause them to sprout. They are then mixed with ground seeds, preferably sunflower seeds, and herbs, spices and vegetable flavors, to form a dough having a selected moisture content, and cooled to produce a dough that has a water content, viscosity, elasticity, tensile strength and cohesiveness such that when sheets of dough having a desired thickness come through the extruder they have a smooth texture, do not wrinkle or curl, hold together without tearing, and do not stick to surfaces of processing equipment with which they come into contact. The sheets are then scored to outline substantially regular-shaped crackers. The sheets are of a viscosity such that the score lines partially heal, so that when later broken along the score lines after drying, they produce crackers having a ragged edge. The scored sheets are dried at a temperature not exceeding 200° F. and in an embodiment of this invention, not exceeding raw-food processing temperatures, to produce a cracker which is crisp, but not brittle, with a slightly chewy texture.

### CROSS-REFERENCE TO RELATED APPLICATION

This application claims priority from U.S. Ser. No. 60/606,578 filed Sep. 1, 2004, which is incorporated herein by reference to the extent not inconsistent herewith.

### BACKGROUND

In the past few years, diets consisting entirely of “raw” foods have become popular. Eating a diet of uncooked food is purported to increase overall health and energy, improve moods and physical appearance, and prevent many diseases including cancer, heart disease, and diabetes. Cooking or dehydration at temperatures above about 120° F. reduces nutrients of foods, including enzymes claimed to be needed for overall health and for digestion and metabolization of foods. Cooking or dehydration at temperatures above about 200° F. destroys many such nutrients. Acrylamide, a carcinogen, has been found in many baked and fried foods which contain carbohydrates, while raw foods do not show traces of this compound (Russell, J., “Could these foods be giving us cancer?” The Guardian, Aug. 15, 2002).

Whole seeds are better for dietary use than broken or ground seeds because the oils within the whole seeds are protected from oxidation and rancidity.

According to the U.S. Department of Agriculture, golden flax seeds contain 27 identifiable cancer-preventive compounds. In addition flax seed is a source of the omega-3 fatty acid, alpha-linolenic acid, which is beneficial in reducing total cholesterol, as well as LDL-cholesterol (the so-called bad cholesterol) and triglyceride levels. Decreased levels of these three lipids in human blood have been associated with decreased risk of cardiovascular disease (P. Kendall, Colorado State University Cooperative Extension, “Just the Flax about Flax seed and Heart Health,” Nutrition News, Mar. 6, 2001; Oomah, B. D. (2001), “Flax seed as a functional food source,” J. Sci. Food Agric. 81:889-894).

Attempts to produce crackers using flax seed have resulted in the publication of several recipes for at-home use. The Flax Council of Canada has published a recipe for flax seed crackers including both whole and ground flax seed, as well as wheat flour. Baking at 160° C. (320° F.) is required. A recipe for flax cookies is also provided which includes flour and sugar, and also requires baking at 350° F. This recipe was republished by Healthcastle.com on their website.

A somewhat more healthful recipe for flax seed crackers not including flour, sugar, or baking temperatures is provided on the rawtimes.com website. This recipe calls for sprouting the flax seeds to produce a mucilage and mixing with pine nuts, followed by dehydration at 80-85° F. for one day. The resultant cracker is described as bland-tasting.

The foregoing recipes have the disadvantage of requiring cumbersome preparation steps not likely to be undertaken by people having busy lifestyles.

Snack foods that can be eaten without cooking or complicated preparation are consumed by choice by people living busy lives. However, many snack foods are low in nutritional value and high in fats and simple carbohydrates, and thus contribute to the bad nutrition endemic in the United States. There is a need for a snack food which is healthy, has a satisfying taste and texture, is low in saturated fats and is high in dietary fiber, and which can be mass produced so that it is readily available without home preparation.

Prior flax seed crackers have been prepared by inventors hereof using home kitchen equipment by methods including soaking the flax seed in an undetermined amount of water for a period of time varying from about one-half hour to several hours, hand-mixing with food-processed, pureed sunflower seeds and other flavor ingredients to form a dough, spreading the dough by hand between two sheets of window screen, and drying in a small Excalibur dehydrator. When a batch of dough was too large to fit into the dehydrator, it was typically stored in a refrigerator until it could be dehydrated. After dehydration, dried material was peeled from the screens, broken by hand into irregular fragments, and packaged in paper bags for sale. However, these methods did not provide sufficiently consistent dough or cracker products to be suitable for mass production. Using this unusual dough, it was difficult to produce a consistently crisp but not brittle product having a uniform thickness necessary to ensure satisfactory crispness, and to ensure freedom from bacterial contamination, since the dough was not subjected to baking temperatures. It was not known if flax crackers could be mass produced with this type of dough, which did not contain wheat flour, what properties might be critical to efficient mass production, or how to control such properties.

An industrial process for producing crackers having stabilized nuts or seeds is provided in U.S. Pat. No. 4,595,596, issued Jun. 17, 1986 to Fazzolare et al. for “Crackers Having Stabilized Sunflower Seeds.” A rolled dough comprising the stabilized seeds is cut into cracker-shaped pieces and then baked at 400 to 550° F.

U.S. Pat. No. 2,437,150 issued Mar. 2, 1948 to Berg for “Compressed Cereal” discloses an industrial process for compressing cereals and other grains into blocks or cubes for ease in packing and transportation, using glycerin as a binder. In the case of a compressed chocolate beverage, the product can be consumed without baking.

A number of other U.S. patents disclose methods and apparatuses for making rice cakes, using temperatures above 200° F. U.S. Pat. No. 4,328,741, issued May 11, 1982, to Yoshikazu, discloses a method and apparatus for making shaped grain products, e.g., rice cakes. The disclosed method comprises the steps of compressing and heating for a predetermined time a raw material such as rice or the like. The raw material is compressed and heated within a hermetically closed chamber defined in upper and lower baking molds at 160-180° C. (320-356° F.). After the predetermined time has elapsed, the compressed and heated raw material is expanded instantaneously by opening the baking molds and concurrently discharging steam produced within the chamber during the compression under heating. The expanded material is compressed again by means of the baking molds, thereby shaping the material into a cracker of desired form and self-sustaining structure. U.S. Pat. No. 5,376,395, issued Dec. 27, 1994, to Pels, also discloses a cooking machine and method for making rice cakes involving heating the rice in a closed mold at temperatures of 215-230° C. (419-446° F.), allowing expansion of the molding volume for a short predetermined period; and opening the molding volume adjacent each end simultaneously and extracting the cooked article. U.S. Pat. No. 5,102,677, issued Apr. 7, 1992, to Van Den Berghe, discloses a similar apparatus and method for making rice cakes involving heating in a closed mold. No heating temperature is disclosed. U.S. Pat. No. 4,888,180, issued Dec. 19, 1989, to Wu, discloses an improved grain cake, such as a rice cake, including a method and apparatus. In the disclosed method, a predetermined quantity of cereal grains is heated in a hermetically sealed chamber at superatmospheric pressure. The heated grains are then expanded while they are confined to the chamber by abruptly releasing the superatmospheric pressure such that the confined, expanded grains bond together to form a self-supporting mass. In this method the cereal grains are pretreated by adding water to the cereal grains to bring their moisture content into the range of about 12% to about 18%. The moistened cereal grains are then steamed to bring them to an effective temperature to partially gelatinize the starch therein (59.5-64° C., which is 139-147° F.) and to maintain the cereal grains at the effective temperature for an effective period of time to produce the desired degree of expansion in the final product. The steamed cereal grains are then dried to a moisture content of less than 18%. Drying is accomplished with the addition of very little or no heat from the dryer. All these processes for producing grain cakes, such as rice cakes, require preheating in a closed mold prior to the drying step.

U.S. Pat. No. 4,451,488, issued May 29, 1984, to Cook et al., discloses a shelf-stable, intermediate moisture, food bar having a soft and chewy texture with good taste. The components are heated to 125° F. degrees to 135° F. This is a chewy granola bar-type product. The process disclosed is not suitable for making a crunchy product.

U.S. Pat. No. 6,821,537 issued Nov. 23, 2004 to Wu, discloses a method for preparing a hand-held snack item such as a rice cake covered with chocolate chips and syrup, comprising applying a first edible, heat-sensitive food material to a formed hand-held food item such as a rice cake; applying a second edible food coating material so as to coat and protect the heat-sensitive food material at a temperature from about 35-350° C. (95-662° F.) up to 10 hours, and then subjecting the food item to this temperature to produce a final, coated snack item. This patent does not disclose how the underlying rice cake is made.

None of the known processes for mass-producing crackers or compressing raw or dried (dehydrated) foods processed at 200° F. or less provides a cracker having a satisfying crunchy taste and texture made using whole seeds such as flax seeds, and not requiring a preheating step inside a mold. Moreover, known mass-production methods provide crackers having a “machine-made” look which is not as attractive to consumers of health foods as the more rough-edged look obtained when crackers are hand-made. A method for retaining the “home-made” look of such crackers is needed which does not sacrifice the ability to produce industrial quantities of a uniformly crisp, non-brittle, and tasty cracker having a substantially regular shape.

### SUMMARY OF THE INVENTION

This invention provides a method for mass producing whole-seed crackers, preferably flax seed crackers, comprising: soaking mucilage-producing whole seeds in water for a period of time necessary to cause said seeds to produce a mucilage, but not long enough to cause said seeds to sprout; mixing the seeds with ground seeds in the presence of sufficient water to form a dough having a moisture content between about 45% and about 55%; cooling the dough to a temperature greater than freezing, but less than about 45° F.; extruding the cooled dough at said temperature; and drying the extruded dough at a temperature not exceeding raw-food processing temperatures to produce a cracker which is crisp, but not brittle. In an embodiment of this invention, the extruded dough is dried at a temperature not exceeding 200° F. The term “raw” with respect to a food means a food that has not been subjected to temperatures above 120° F. The term “dehydrated” with respect to a food, as used herein, means a food that has been dried (dehydrated) and has not been subjected to cooking at a temperature higher than 200° F. The “dehydrated” foods of this invention include the “raw” foods of this invention.

The term “crisp” means that the cracker breaks when bent, making a snapping sound. The term “not brittle” means that the cracker does not shatter when subjected to a perpendicular blow, and has a slightly chewy texture when eaten.

Mucilage-producing seeds include flax seeds, other edible seeds of the genus Linum, psyllium and other edible seeds of the genus Plantago, chias, and mixtures thereof, and other such seeds known to the art. The ground seeds, which are used to add body and texture, are preferably sunflower seeds which have been presoaked for the purpose of softening for grinding into a puree. Other flavorful seeds such as pumpkin seeds and the edible portion of nuts may also be used instead of sunflower seeds. Mixtures of different ground seeds and nuts may also be used.

To achieve the desired crisp, non-brittle texture, it is necessary to control the thickness and moisture content of the cracker, and to control the viscosity, moisture content, elasticity, tensile strength, and cohesiveness of the dough to be extruded.

The thickness of the finished cracker should be between about 0.070 and about 0.090 inches. “Uniform thickness” with respect to the finished crackers is defined herein as thickness varying no more than about 0.20 inches, more preferably no more than about 0.15 inches. The moisture content of the finished cracker should be between about 2% and about 4%, preferably between about 2.5% and about 3.5%. The dough at the time of extrusion should have a moisture content of between about 45% and about 55%, more preferably between about 47% and about 53%, and most preferably between about 48% and 52%. The water content, viscosity, elasticity, tensile strength, and cohesiveness of the dough should be sufficient that when sheets of dough come through the extruder onto the moving tray, they have a smooth texture, more like toothpaste than cottage cheese, do not wrinkle or curl, and hold together without tearing. The temperature of the dough as it goes through the extruder should be between just above freezing and about 45° F., more preferably between about 38 and about 42° F., and most preferably about 40° F. The temperature should be such that the dough is capable of sticking to itself, but not to the surfaces of processing equipment, e.g., extruder surfaces.

The dough is extruded through a slit sized to produce a sheet of desired uniform thickness. “Uniform thickness” with respect to the sheets of dough is defined herein as having a thickness variance of no more than about 0.20 inches, preferably no more than about 0.15 inches. The sheets are then scored to outline desired cracker shapes. Preferably the crackers are of a substantially regular shape, such as square or rectangular, to facilitate packaging. The viscosity of the dough is such that some of the dough flows back into the score lines so that the crackers are not completely separated from each other at this stage of the process. This is to facilitate later breaking of the sheets to form crackers having ragged edges to provide a “homemade” look and feel.

In an embodiment of this invention, the extruded sheets, after scoring, are dried at a temperature not exceeding raw-food processing temperature, i.e., not exceeding about 120° F. No preheating or cooking of the ingredients is required prior to drying. Preferably the drying temperature is 110° F. or less. Temperatures should be high enough to discourage bacterial growth and allow for drying times to be as short as possible. In some embodiments minimum drying temperatures are about 102° F., or about 105° F., or about 108° F. A useful drying temperature is about 109° F. Drying is continued until the cracker has a crisp, but not brittle texture, generally for between about eight and about twelve hours, and more preferably for about eight hours.

In an embodiment of this invention, the drying temperature is less than about 200° F., which allows drying time to be reduced to about three to four hours while still avoiding destruction of many nutrients. Other drying temperatures useful in this invention include any temperature between about 100 and 200° F.

The humidity in the dryer is maintained between about 10% and about 20% in order to control the moisture content of the finished cracker and ensure proper drying.

Following drying, the sheets are broken by any means known to the art, preferably using a mechanical breaking device which exerts a bending pressure on the sheets along the score lines, resulting in crackers having the desired ragged edges, preferably with a uniform rectangular shape. Breaking of the extruded, scored and dried sheets is preferably accomplished by conveying the sheets through a device comprising a roller or set of rollers that causes the sheets to bend or change direction while moving, thus exerting pressure along the score lines. Where the sheets have been scored in the machine direction and in the cross direction, they can be subjected to a bending pressure exerted in the cross direction by being conveyed over a roller or bump while vertical pressure is exerted downward by another roller or bump to cause the sheets to break along the cross-direction score lines. The orientation of the sheets can then be changed, e.g., they can be rotated 90 degrees and then conveyed through the same or a similar device to break them along the machine-direction score lines. An alternate means for breaking the sheets along the machine-direction score lines is to run them through a U-shaped depression using soft rollers to press them down into the U shape, thus exerting a bending pressure near the machine-direction score lines and causing them to break along these lines.

Crackers made by the methods of this invention have a substantially regular square or rectangular shape, and also have ragged edges.

### BRIEF DESCRIPTION OF THE FIGURES

FIG. 1 is a flow diagram of the overall process of making flax crackers in accordance with this invention.

FIG. 2 is a more detailed flow diagram of the mixing process of this invention. FIGS. 2A-2C, placed vertically in sequence, show this entire mixing process.

FIG. 3 is a more detailed flow diagram of the forming process of this invention. FIGS. 3A-3B, placed vertically in sequence, show this entire forming process.

FIG. 4 is a more detailed flow diagram of the drying process of this invention.

FIG. 5 is a more detailed flow diagram of the wrapping process of this invention. FIGS. 5A-5B, placed side by side in sequence, show this entire wrapping process.

FIG. 6 is a more detailed flow diagram of the packaging process of this invention. FIGS. 6A-6B, placed side by side in sequence, show this entire packaging process.

### DETAILED DESCRIPTION OF SPECIFIC EMBODIMENTS

The method of this invention for mass producing whole-flax seed crackers comprises soaking flax seeds in approximately the same weight of water for about one-half hour, until they produce a mucilage which is useful as a binder for the dough. Preferably the water is not drained from the flax seeds. Separately, sunflower seeds are soaked for a period of about five to about ten minutes in about 0.5 to about 0.7 pounds of water per pound of sunflower seeds for the purpose of softening so that they can be ground into a puree. The water is then drained so as to dispose of enzyme inhibitors present in the water after soaking, and to ensure the proper water balance in the dough. The sunflower seeds are then pureed and added to the flax seeds and water. Enough additional water is added to form a slurry. Flavor ingredients may be added at this point. The ingredients are then mixed in a commercial mixer such as a Hobart blender. Additional ingredients for flavor can also be added during mixing. The timing of addition of additional flavor ingredients will depend on how well the ingredients are incorporated into the slurry prior to or during mixing. The mixed material, termed a “dough” herein, is sampled for moisture content and taste, and adjusted accordingly. The moisture content of the dough should be between about 45% and about 55%. If the moisture content is too high, additional solid ingredients are added; if it is too low, additional water is added.

For best results, the ratio of flax seeds to sunflower seeds should be between about 21:1 and about 4:1, preferably between about 15:1 and about 8:1, and more preferably about 3:1; and the ratio of total seeds to water should be between about 1.5:1 and about 0.75:1 preferably between about 1.25:1 and about 1.0:1, and more preferably about 1.1:1. Additional flavor ingredients are added to taste, preferably natural, organically-grown ingredients.

The dough is then rapidly cooled to a temperature of about 40° F., and at this point should have a water content, viscosity, tensile strength, and cohesiveness as discussed above. Its cohesiveness or “stickiness,” should be such as to enable the dough to stick to itself but not to processing equipment surfaces. It is important that the cooling be rapid to avoid bacterial growth in the dough. After mixing, the dough is immediately placed in the cooling unit.

The dough is then placed into a hopper for feeding into a twin-screw extruder. Although any extruder known to the art may be used, a double-screw extruder is preferred for more uniform pressure and less abuse of the product. The extruder slit is adjusted to produce an extruded sheet having a uniform thickness between about 0.070 and about 0.090 inches, which is deposited onto a tray on a moving conveyor. The tray is covered with a layer of plastic mesh of a mesh size approximately equal to the size of conventional window screen mesh, to prevent the dough from sticking to the bottom of the tray and to allow air access during subsequent drying.

The extruded sheets are then scored using a paddle-style cutting tool for cross-direction scoring and a set of ganged circular blades for machine-direction scoring.

The scored sheets are then placed on racks and the racks are placed as quickly as possible in a commercial gas-fired dehydrator and dried at a temperature of 109° F. Faster drying can be achieved by raising the temperature, however the temperature should be kept below 200° F. The mixed dough should be extruded and dried within no more than about 24 hours to avoid bacterial contamination.

The scored sheets should not be allowed to sit at room temperature for more than about one hour so that bacterial growth can be avoided, and also to help prevent case hardening. Case hardening occurs when an outer, dry shell forms on dough, which seals moisture into the inside of the dough The humidity in the dryer is kept at between about 10 and about 20%. At the beginning of drying, the humidity is kept higher to prevent case hardening, and then decreased to speed up the drying process. The drying at 109° F. is continued for about eight hours. At temperatures closer to 200° F. drying time can be reduced to three or four hours. The drying sheets are sampled for moisture content at intervals, e.g., about four hours while drying, using an infrared sampler or other sampling device known to the art capable of providing immediate results. Drying is complete when the moisture content reaches about 2.5%.

The dried sheets are then placed on a conveyor and broken along the score lines by passing the sheets through a roller component that causes them to change direction, thereby stressing them along the cross-direction score lines and causing them to break along the stressed score line; and then passing the partially broken sheets through a roller component that causes them to change direction, thereby stressing them along the machine-direction score lines and causing them to further break along these score lines, thereby forming rectangular or square crackers having ragged edges. Alternatively, the sheets may first be broken along the machine-direction score lines and then along the cross-direction score lines.

### EXAMPLES

### Example 1

### Smokey Onion Reduced Salt Flax Crackers

The following ingredients are used to prepare a flax cracker having an oniony, spicy/pepper, sweet, nutty, salty taste: flax seeds, sunflower seeds, onions, sea salt, hickory salt (salt, hickory smoke [torula yeast and hickory smoke] nutritional yeast, and paprika), and black pepper. The sunflower seeds are soaked in water and drained, and the flax seeds are soaked in water and not drained.

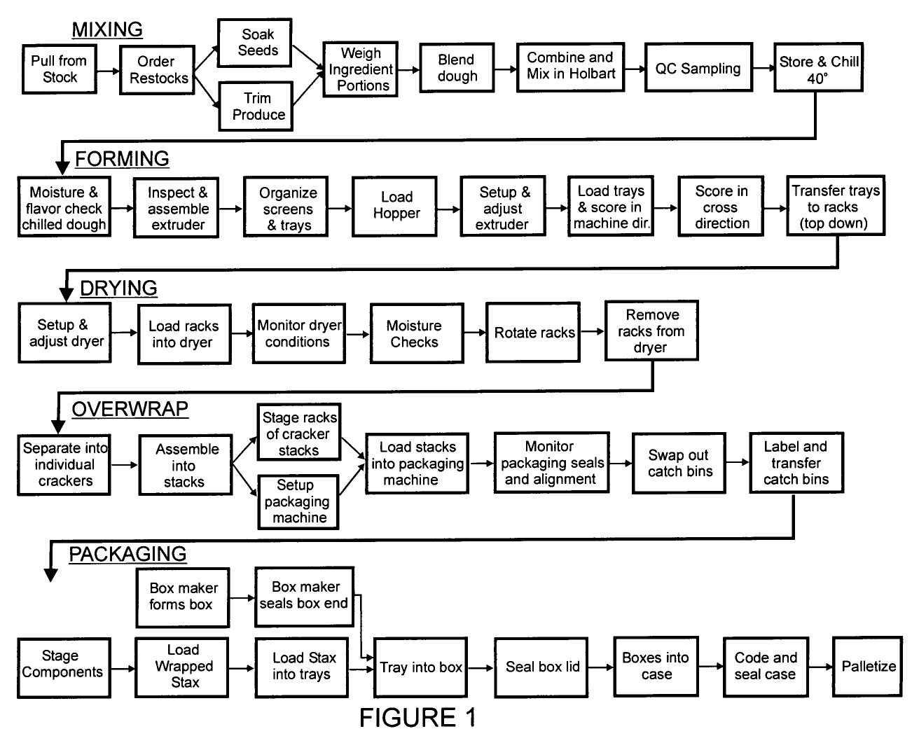

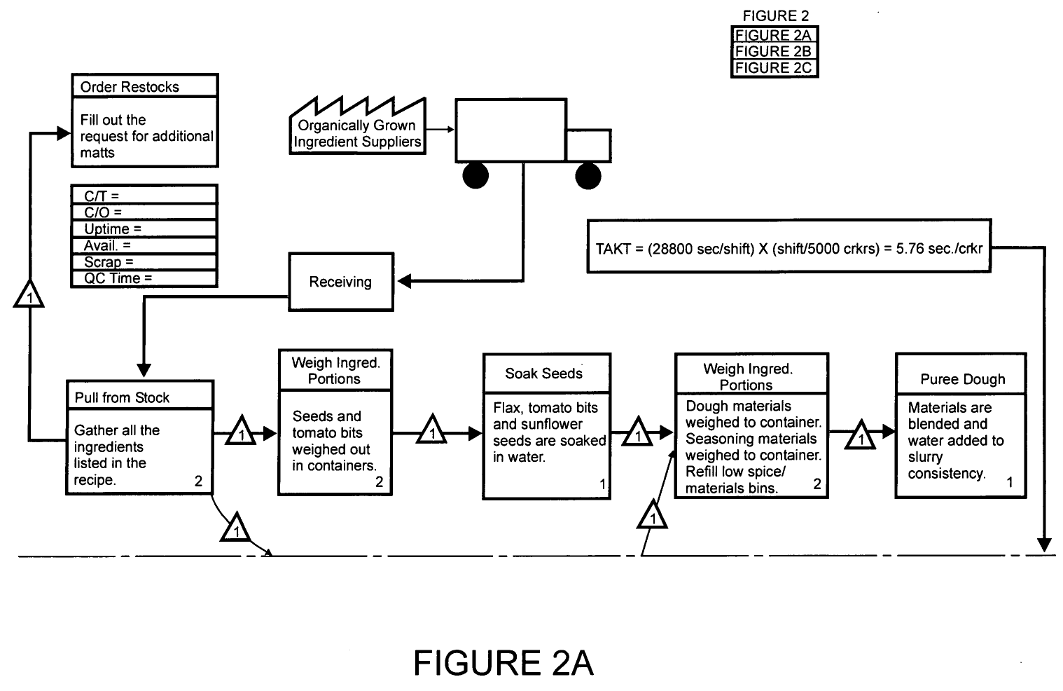

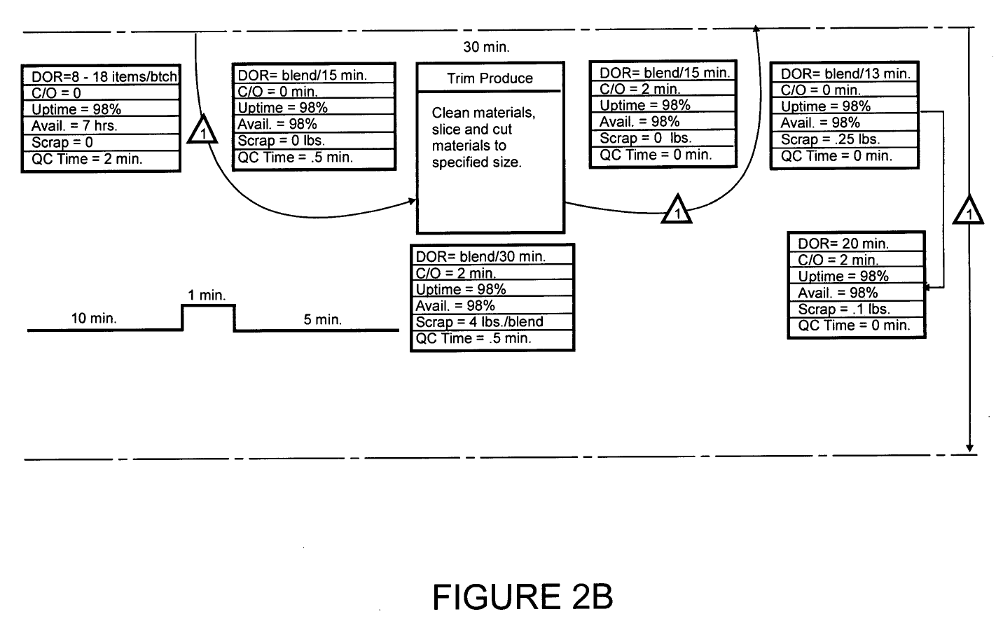

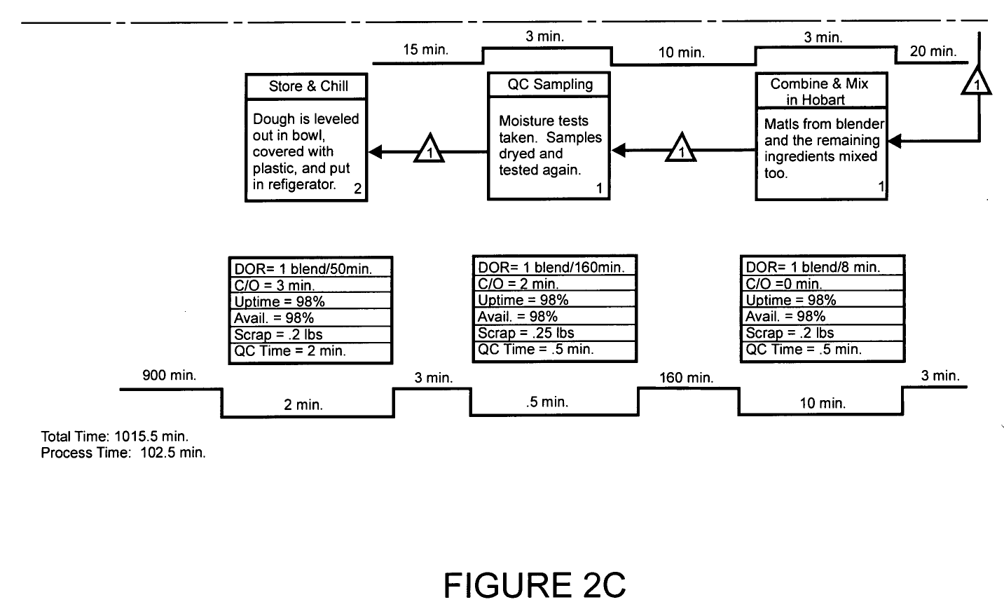

As shown in FIG. 1, and in greater detail in FIG. 2, mixing of the ingredients is performed. The seeds are soaked, ingredients are weighed, and dough is blended from the seeds and other ingredients with the addition of enough water to form a slurry. Additional seasoning ingredients may be added to the slurry as it is mixed in a Hobart blender by distributing dry spices around various locations in the blender bowl. Care is taken to avoid pockets of unmixed material. Quality control sampling is done to assess moisture. The moisture content should be between about 45% and about 55%. Samples are dried in an Excalibur drier and tasted, and seasoning of the dough is adjusted if necessary. The dough is then immediately leveled out in a bowl, covered with plastic and refrigerated to a temperature of about 40° F.

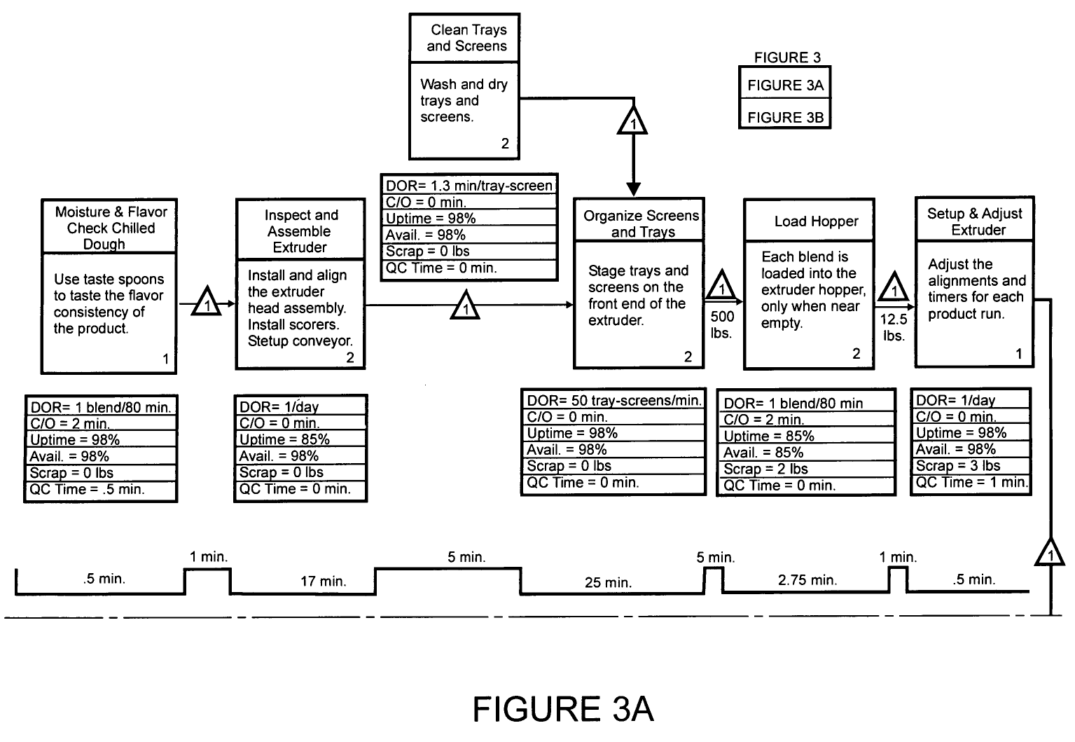

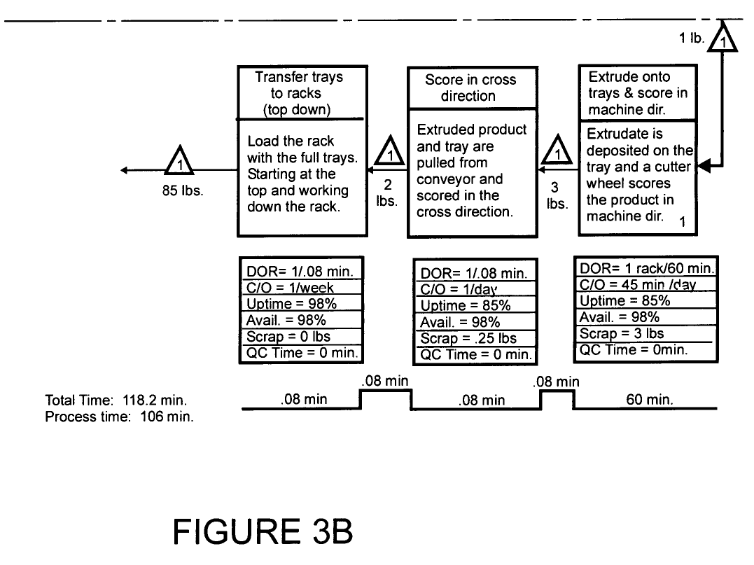

The chilled dough is then formed as shown in FIG. 1, and in more detail in FIG. 3. The chilled dough is again tested for moisture content and flavor as discussed above, and adjusted if necessary. The dough is then loaded into a hopper for feeding to a Vemag twin screw extruder, and sheets of dough are extruded onto trays lined with a layer of plastic screen material, and then scored in the machine direction using a ganged set of circular blades. The sheets are then scored in the cross direction using a paddle-style cutting tool. Trays of scored sheets are then transferred to racks for drying.

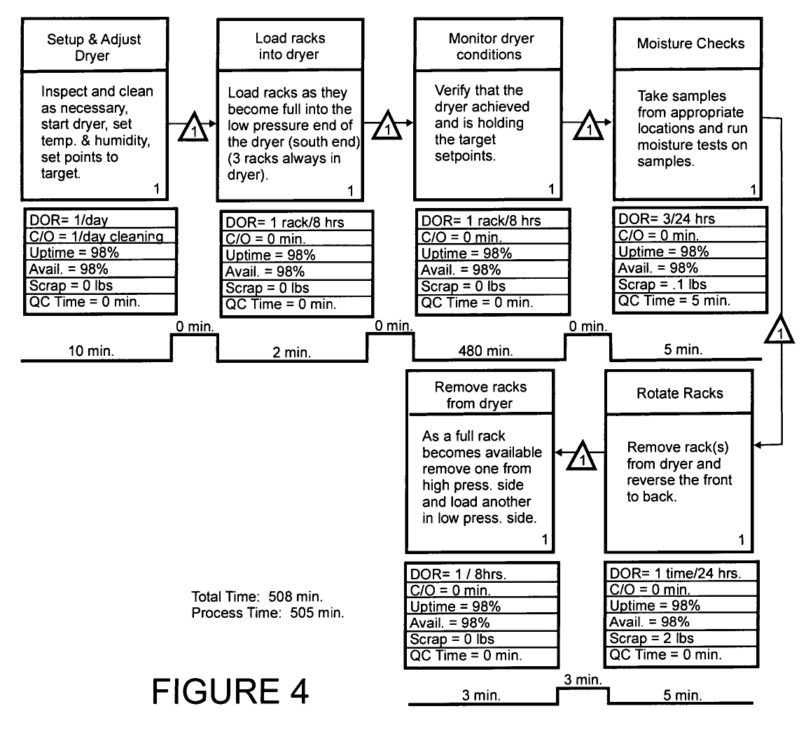

The scored sheets are then placed in a dehydrator as quickly as possible, i.e., within no more than about 90 minutes, and dried as shown in FIG. 1, and in more detail in FIG. 4. Racks loaded with scored sheets are loaded into a commercial direct gas-fired commercial dehydrator at a temperature of about 109° F. and a humidity of about 10 to about 20%. Dryer conditions are monitored throughout the drying period of about eight hours, and moisture checks are performed during drying, at about four-hour intervals. Racks are rotated within the dryer for uniformity of drying and then removed from the dryer.

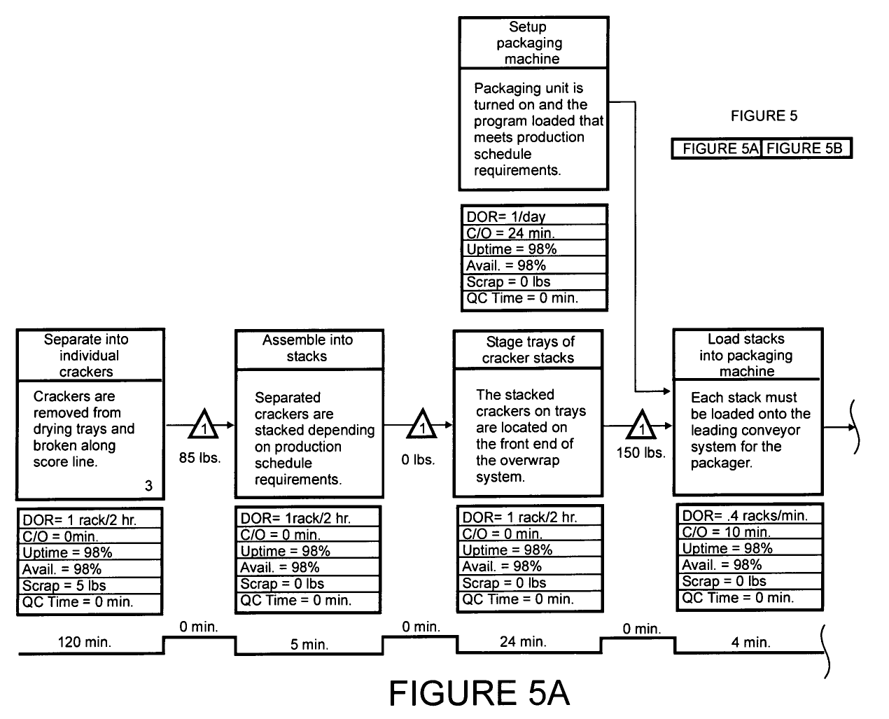

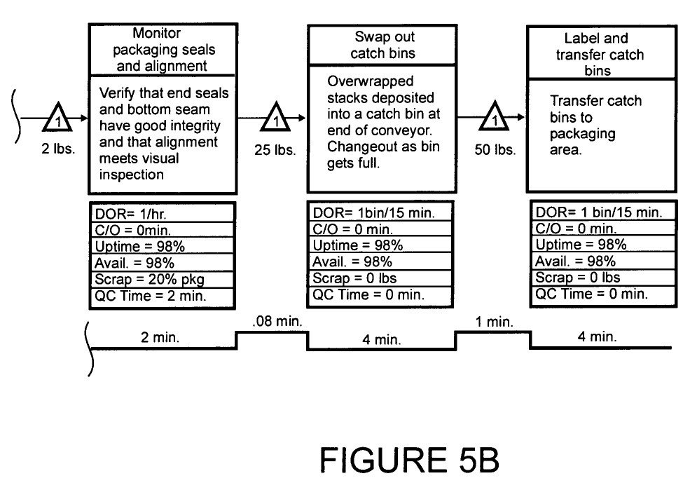

The dried sheets are then broken into individual crackers and overwrapped as shown in FIG. 1, and in more detail in FIG. 5. Dried sheets are conveyed over one roller and under another to exert a bending pressure along the machine-direction score lines, causing the sheets to break along these lines, and then are turned sideways and run through similar rollers to break them along the cross-direction score lines. After breaking, the crackers are assembled into stacks, placed on racks and loaded into a wrapping machine. Seals and alignment are monitored during operation of the packaging machine, wrapped crackers are deposited in catch bins, and the bins are labeled and transferred to packaging.

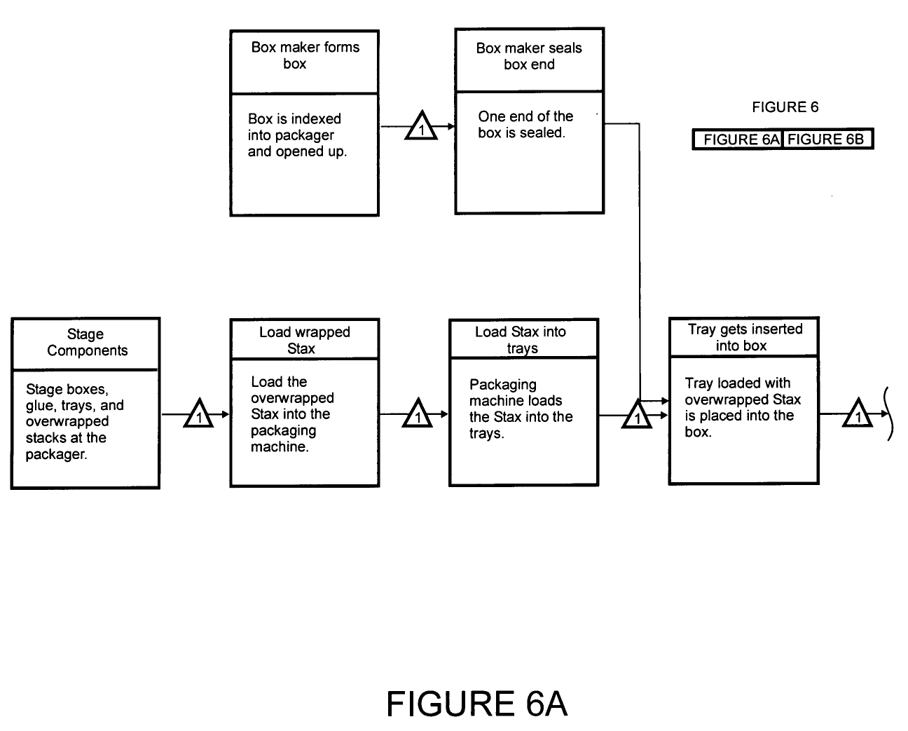

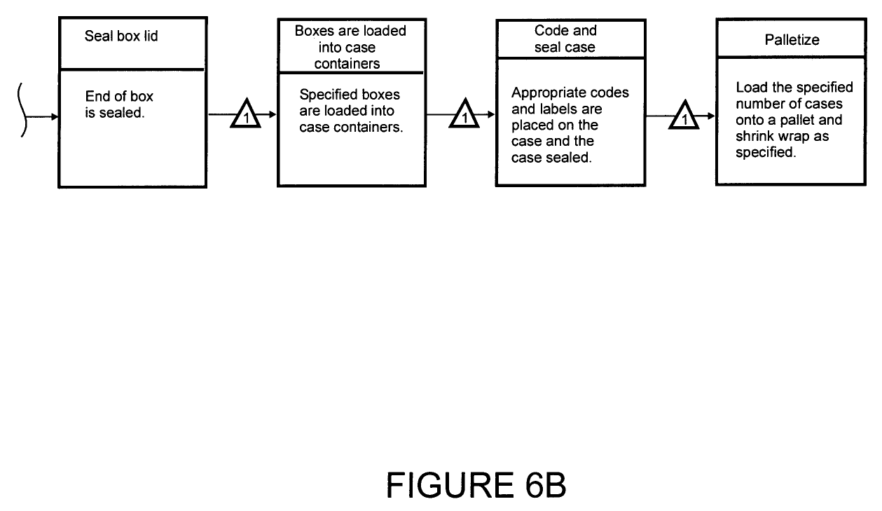

Wrapped crackers are then packaged (boxed) as shown in FIG. 1, and in more detail in FIG. 6. Boxes are formed in a box maker which seals one end of the box. Wrapped stacks of crackers are loaded into the packaging machine, which loads the stacks into trays which are inserted into the box, and the end of the boxes are sealed. Sealed boxes are then loaded into case containers which are coded and sealed, and the cases are then loaded onto a pallet and shrink wrapped.

### Example 2

### Indian Curry Reduced Salt Flax Crackers

The following ingredients are used to prepare a flax cracker having a salty, peppery hot, nutty, cumin, spicy, bitter taste: Golden Flax seeds, sunflower seeds, brown flax seeds, carrots, soy sauce, sea salt, red chili powder (chili powder, cumin, oregano, coriander, garlic, microcrystalline cellulose [a natural anti-caking agent], allspice and cloves), garlic powder, cumin, celery salt, (salt and ground celery seed), fenugreek, ginger, coriander, turmeric, white pepper, cayenne pepper and yellow mustard seed. The seeds are soaked and drained as in Example 1. The carrots are blended in a large Robot-coupe with Namu shoyu and four pounds of water, and this water is not drained. The ingredients are then mixed and processed as set forth in Example 1.

### Example 3

### Tomato Herb Reduced Salt Flax Crackers

The following ingredients are used to prepare a flax cracker having a herby, salty, nutty, sour sweet tomato taste: Flax seeds, sunflower seeds, tomatoes, tomato flakes, sea salt, garlic flakes, garlic, oregano, red chili flakes, basil, chives, parsley and black pepper The seeds are soaked and drained as in Example 1. The tomato flakes are also soaked, and the water not drained. The ingredients are then mixed and processed as set forth in Example 1.

### Example 4

### Jamaican Spice Reduced Salt Flax Crackers

The following ingredients are used to prepare a flax cracker having a hot spicy taste: Flax seeds, sunflower seeds, onions, coconut flakes, ginger, garlic flakes, red chili powder (chili powder, cumin, oregano, coriander, garlic, microcrystalline cellulose [a natural anti-caking agent], allspice and cloves), onion powder, sea salt, unpasteurized soy sauce, cayenne pepper, hickory salt (salt, hickory smoke [torula yeast and hickory smoke], nutritional yeast and paprika), yellow mustard seed, cumin and turmeric. The seeds are soaked and drained as in Example 1. The coconut is also soaked, and the water not drained. The ingredients are then mixed and processed as set forth in Example 1.

This invention has been illustrated using specific embodiments, for example specific ingredients and processing equipment; however, as will be appreciated by those skilled in the art, specific ingredients, processing equipment and other conditions may be substituted for those described, and equivalents of those described may be used to practice this invention.

1. A method for mass-producing whole-seed crackers comprising:
a) soaking mucilage-producing whole seeds in water for a period of time necessary to cause said seeds to produce a mucilage, but not long enough to cause said seeds to sprout;
b) mixing said seeds with ground seeds in the presence of sufficient water to form a dough having a moisture content between about 45% and about 55%;
c) cooling said dough to a temperature greater than freezing, but less than about 45° F.;
d) extruding said dough at said temperature to form a sheet; and
e) drying said extruded dough at a temperature not exceeding about 200° F.;
wherein said cooled dough has a water content, viscosity, elasticity, tensile strength and cohesiveness sufficient that when sheets of dough come through the extruder, they have a smooth texture, do not wrinkle or curl, hold together without tearing, and do not stick to surfaces of processing equipment with which they come into contact.

2. The method of claim 1 wherein said drying step is performed at a temperature not exceeding about 120° F.

3. The method of claim 1 wherein said drying temperature is between about 102° F. and about 120° F.

4. The method of claim 1 wherein said drying temperature is between about 105° F. and about 109° F.

5. The method of claim 1 wherein said whole mucilage-producing seeds are selected from the group consisting of edible seeds of the genus Linum, edible seeds of the genus Plantago, chias, and mixtures thereof.

6. The method of claim 1 wherein said ground seeds are selected from the group consisting of sunflower seeds, pumpkin seeds, and edible portions of nuts, and mixtures thereof.

7. The method of claim 1 comprising extruding said dough through a slit that is sized to form a sheet of desired uniform thickness.

8. The method of claim 7 wherein said thickness is between about 0.070 and about 0.090 inches.

9. The method of claim 1 wherein humidity during said drying step is controlled at between about 10% and about 20%.

10. The method of claim 1 wherein said drying step is performed until said cracker has a crisp, non-brittle texture.

11. The method of claim 10 wherein said drying step is performed for a period between about 3 and about 12 hours.

12. The method of claim 1 for producing whole-seed crackers having a substantially regular shape comprising scoring said sheet to produce score lines in said sheet corresponding to the desired shape of said crackers.

13. The method of claim 12 wherein said scoring produces machine-direction and cross-direction lines and the desired shape of said crackers is rectangular or square.

14. The method of claim 12 also comprising breaking the scored sheet to form crackers having a ragged edge.

15. The method of claim 14 where said breaking is done by passing said sheet through a breaking component that causes the sheet to change direction, thereby stressing said sheet along said cross-direction or machine-direction score lines and causing the sheet to break along the stressed score line; and thereafter passing said broken sheet through a breaking component that causes the sheet to change direction, thereby stressing the sheet along the remaining unbroken score lines and causing the sheet to further break along these score lines, thereby forming rectangular or square crackers.

16. A cracker made by the method of claim 1 having a substantially regular square or rectangular shape.

17. A method for mass-producing whole-seed crackers comprising:
a) soaking mucilage-producing whole seeds in water for a period of time necessary to cause said seeds to produce a mucilage, but not long enough to cause said seeds to sprout;
b) mixing said seeds with ground seeds in the presence of sufficient water to form a dough having a moisture content between about 45% and about 55%;
c) cooling said dough to a temperature greater than freezing, but less than about 45° F.; wherein said cooled dough has a stickiness enabling said dough to stick to itself but not to processing equipment surfaces;
d) extruding said dough at said temperature to form sheets having a thickness between about 0.070 and about 0.090 inches; and
e) drying said sheets at a temperature between about 102° F. and about 200° F. at a humidity of about 10% to about 20% for a period of about three to about twelve hours, whereby said dried sheets have a thickness between about 0.070 and about 0.090 inches and have a crisp, non-brittle texture.

18. The method of claim 17 wherein said whole mucilage-producing seeds are selected from the group consisting of edible seeds of the genus Linum, edible seeds of the genus Plantago, chias, and mixtures thereof.

19. The method of claim 1 wherein said ground seeds are selected from the group consisting of sunflower seeds, pumpkin seeds, and edible portions of nuts, and mixtures thereof.

20. A method for mass-producing whole-flax seed crackers comprising:
a) soaking the flax seeds in water for about one-half hour to cause said seeds to produce a mucilage, but not long enough to cause said seeds to sprout;
b) mixing the flax seeds with ground sunflower seeds in the presence of sufficient water to form a dough having a moisture content between about 45% and about 55%;
c) cooling said dough to a temperature between about 38° F. and about 45° F.;
d) extruding the cooled dough to produce a sheet of said dough; wherein said cooled dough has a water content, viscosity, elasticity, tensile strength and cohesiveness sufficient that when sheets of dough come through the extruder, they have a smooth texture, do not wrinkle or curl, hold together without tearing, and do not stick to surfaces of processing equipment with which they come into contact;
e) scoring said sheet to produce score lines defining crackers of a desired shape and size;
f) drying said sheet at a temperature between about 105° F. and about 110° F. and a humidity between about 10 and about 20% for a period of time between about 480 and about 720 minutes; and
g) breaking the scored, dried sheet along the score lines, thereby forming crackers having ragged edges.
